(19) United States
(12) Patent Application Publication
(10) Pub. No.: US 2016/0019284 A1
(43) Pub. Date: Jan. 21, 2016

(54) SEARCH ENGINE USING NAME CLUSTERING

(71) Applicant: Linkedln Corporation, Mountain View, CA (US)

(72) Inventor: Sriram Sankar, Palo Alto, CA (US)

(21) Appl. No.: 14/335,190

(22) Filed: Jul. 18, 2014

(51) Int. Cl. G06F 17/30

(52) U.S. Cl. CPC G06F 17/30598; G06F 17/30864

(57) ABSTRACT

A system maintains a plurality of names. The system generates cluster ids based on the names, and forms first clusters by grouping names having an equivalent cluster id. Then, for each cluster, and for each unique name in each cluster, the system keeps the unique name in the cluster when the unique name is similar to each other unique name in the cluster. The system can also receive a name entered by a user. The system generates a cluster id for the name entered by the user. The system retrieves a cluster having an equivalent cluster id as the cluster id of the name entered by the user. The system forms a construct that includes the name entered by the user and unique names in the retrieved cluster. The system searches for names within a population using the construct as search criteria.

### TECHNICAL FIELD

The subject matter disclosed herein generally relates to a search engine using name clustering.

### BACKGROUND

A social and/or business networking system maintains data about thousands if not millions of people. This data can include a profile of each member of the social networking system. These profiles can include information relating to a person's educational history, employment history, skill set, and other pertinent information about the person. Such a social networking system normally provides to its users the ability to conduct searches on the system. These searches can be for a particular person in the system using the person's name, and/or can be a search about a person(s) (such as people who have experience in a certain job skill).

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social networking server.

FIG. 3 is a block diagram showing some of the functional components or modules that comprise a processing engine of a social network server.

FIGS. 4A, 4B, and 4C are a block diagram illustrating operations and features of a process and system for a search engine using name clustering.

FIG. 5 illustrates an example of a cluster id table.

FIG. 5A illustrates another example of a cluster id table.

FIG. 6 illustrates an example of a final cluster table.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to a search engine using name clustering. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In an embodiment, a social networking and/or business networking system includes a search engine that includes a name clustering function. Such a name clustering function first involves a rough clustering, which can also be referred to as a level 1 clustering. The level 1 clustering creates a rough cluster id for each name in a population (e.g., each member in a social networking system). It is referred to as a rough cluster id because the cluster id is too coarse. That is, there are too many false positives. The rough clustering is based on a normalization of members' names in the population. In one example, the normalization involves the removal of vowels and repeated characters (consonants) from the member names, and in another embodiment, the normalization generates a table having three columns. The three columns relate to the member names, the cluster ids, and the number of occurrences of the name.

The system takes each cluster that was generated in the rough clustering function, and breaks up each cluster into final name clusters. The final name clusters are generated by comparing all names in a cluster against each other, and determining the similarity among the names in the cluster. For each cluster, this results in an O(N̂2) algorithm, wherein N is the size of the cluster. When these comparisons are positive (i.e., the comparison indicates that a name in the cluster is similar to all other names in the cluster), the names are kept together in the final name cluster by performing a transitive closure. In an embodiment, the generation of final name clusters produces a five column table. The columns in the table relate to the member name, the number of times the member name occurs in the social networking system, the canonical name of this cluster (or the cluster name, which is the most commonly occurring name in the cluster), the number of times the cluster name occurs the final cluster, and the cluster id.

The final name clusters are filtered. In an embodiment, the filtering is based on a threshold of the count of each of the unique names in the final cluster. For example, if a particular unique name occurs less than three times in the final cluster, then that particular unique name can be filtered out. Such a name can be filtered out since it could be a misspelling of a name. If it is not a misspelling, it may simply be a relatively rare name that will not be used in a construction of search criteria, as is explained in more detail below. The final cluster is then indexed. The final cluster is also provided to a query rewriter that contains a mapping of prefixes of names to the cluster id.

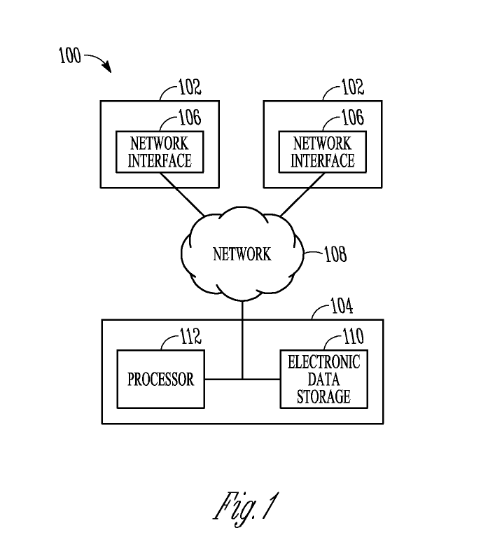

FIG. 1 is a block diagram of a system 100 including user devices 102 and a social network server 104. In an embodiment, a particular type of social network server can be referred to as a business network server. User devices 102 can be a personal computer, netbook, electronic notebook, smartphone, or any electronic device known in the art that is configured to display web pages. The user devices 102 can include a network interface 106 that is communicatively coupled to a network 108, such as the Internet.

The social network server 104 can be communicatively coupled to the network 108. The server 104 can be an individual server or a cluster of servers, and can be configured to perform activities related to serving the social network, such as storing social network information, processing social network information according to scripts and software applications, transmitting information to present social network information to users of the social network, and receive information from users of the social network. The server 104 can include one or more electronic data storage devices 110, such as a hard drive, and can include a processor 112.

The social network server 104 can store information in the electronic data storage device 110 related to users and/or members of the social network, such as in the form of user characteristics corresponding to individual users of the social network. For instance, for an individual user, the user's characteristics can include one or more profile data points, including, for instance, name, age, gender, profession, prior work history or experience, educational achievement, location, citizenship status, leisure activities, likes and dislikes, and so forth. The user's characteristics can further include behavior or activities within and without the social network, as well as the user's social graph. For an organization, such as a company, the information can include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

The ability to generate cluster ids based on names in the social networking system 100, by grouping names having an equivalent cluster id, and finalizing clusters wherein each name in the cluster is similar to each other name in the cluster, can be achieved with a general processing engine. The general processing engine may execute in real-time or as a background operation, such as offline or as part of a batch process. In some examples that incorporate relatively large amounts of data to be processed, the general processing engine may execute via a parallel or distributed computing platform.

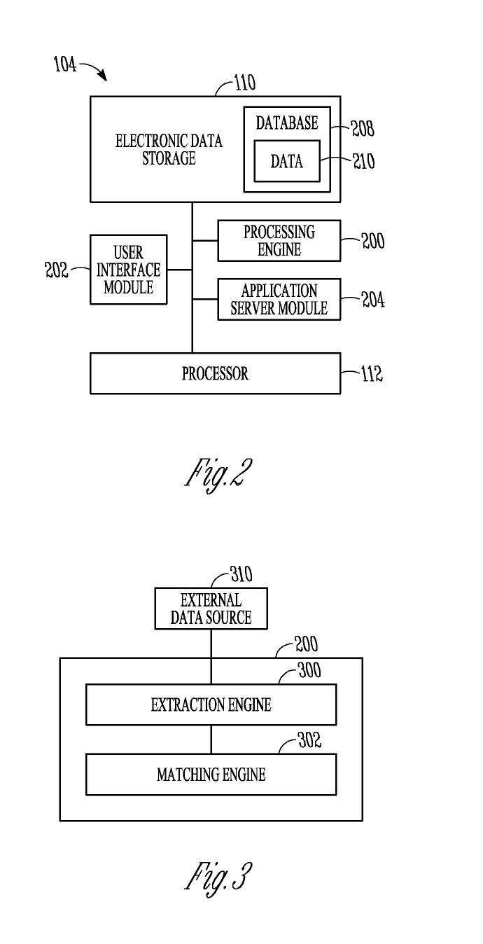

FIG. 2 is a block diagram illustrating various components of a social networking server 104 with a processing engine 200 for identifying similarities between different processing entity types and other processing, such as identifying similarities between cluster ids and similarities of names in a cluster. In an example, the social networking server 104 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social networking server 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network server 104 consists of a user interface module (e.g., a web server) 202, which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 202, generates various user interfaces (e.g., web pages) with data retrieved from various data sources in the data layer. With some embodiments, individual application server modules 204 are used to implement the functionality associated with various services and features of the system 100. For instance, the ability to determine cluster ids and maintain or remove names from clusters may be a service implemented in an independent application server module 204. Similarly, other applications or services, such as searching for particular names on the social networking system 100, can utilize the processing engine 200 or may be embodied in their own application server modules 204.

The data layer 110 can include several databases, such as a database 208 for storing data 210 such as job profiles, general employee profiles, specific employee profiles, company profiles, and job postings, and can further include additional social network information, such as interest groups, companies, advertisements, events, news, discussions, tweets, questions and answers, and so forth. In some examples, the data are processed in the background (e.g., offline) to generate pre-processed data that can be used by the processing engine, in real-time, and to make recommendations or report results generally.

In various examples, when a person initially registers to become a user (and/or member) of the system 100, the person can be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. This information can be stored, for example, in the database 208.

The network interface 106 can provide the input of user data, such as user characteristics or profile data, or a name or other criteria for a search, into the social network. The user data can be stored in the database 208 or can be directly transmitted to the processing engine 200 for processing. Jobs posting and other data and results identified by or processed by the processing engine 200 can be transmitted via the network interface 106 to the user device 102 for presentation to the user.

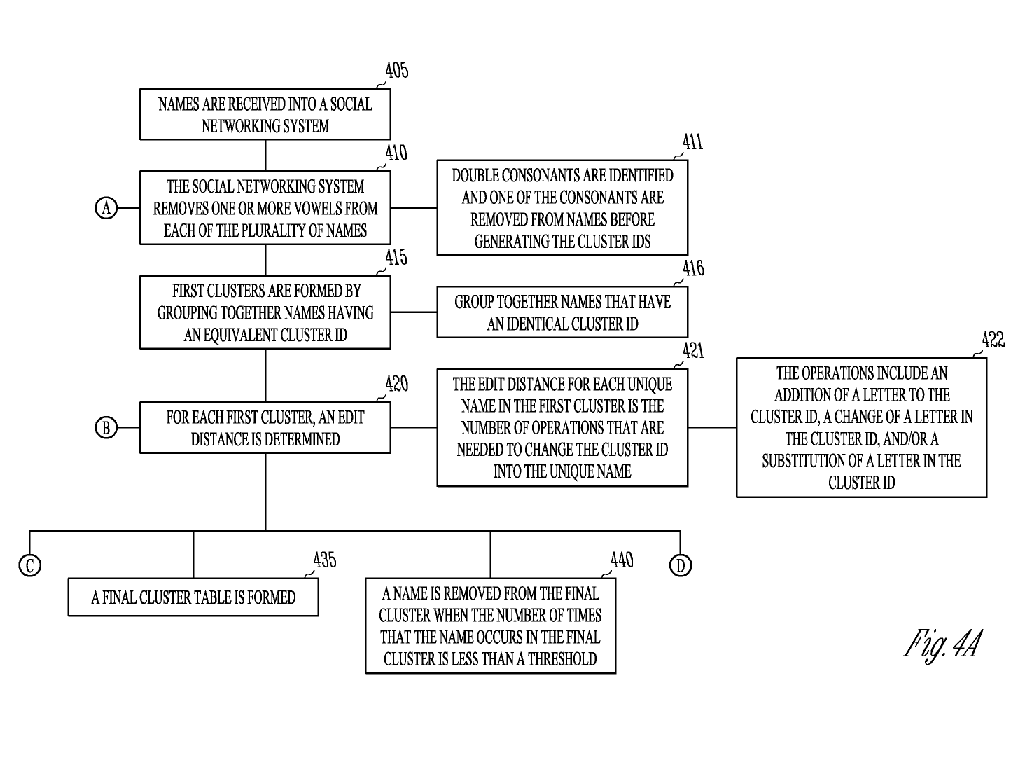

FIG. 3 is a block diagram showing some of the functional components or modules that comprise a processing engine 200, in some examples, and illustrates the flow of data that occurs when performing various operations of a method for forming cluster ids and clusters, and searching for persons or other data in a social networking system. As illustrated, the processing engine 200 consists of two primary functional modules—an extraction engine 300 and a matching engine 302, and can be coupled to an external data source 310. The extraction engine 300 can extract data from a user profile, a company profile, an employee profile of a business organization, a job posting, and a job profile, and then operating the matching engine 302 under the direction of a particular configuration file 304 perform a particular type of matching operation that is specific to the requesting application (such as matching a person's name in a profile to a name entered by a user of the social networking service (or equivalent names provided by the social networking service)).

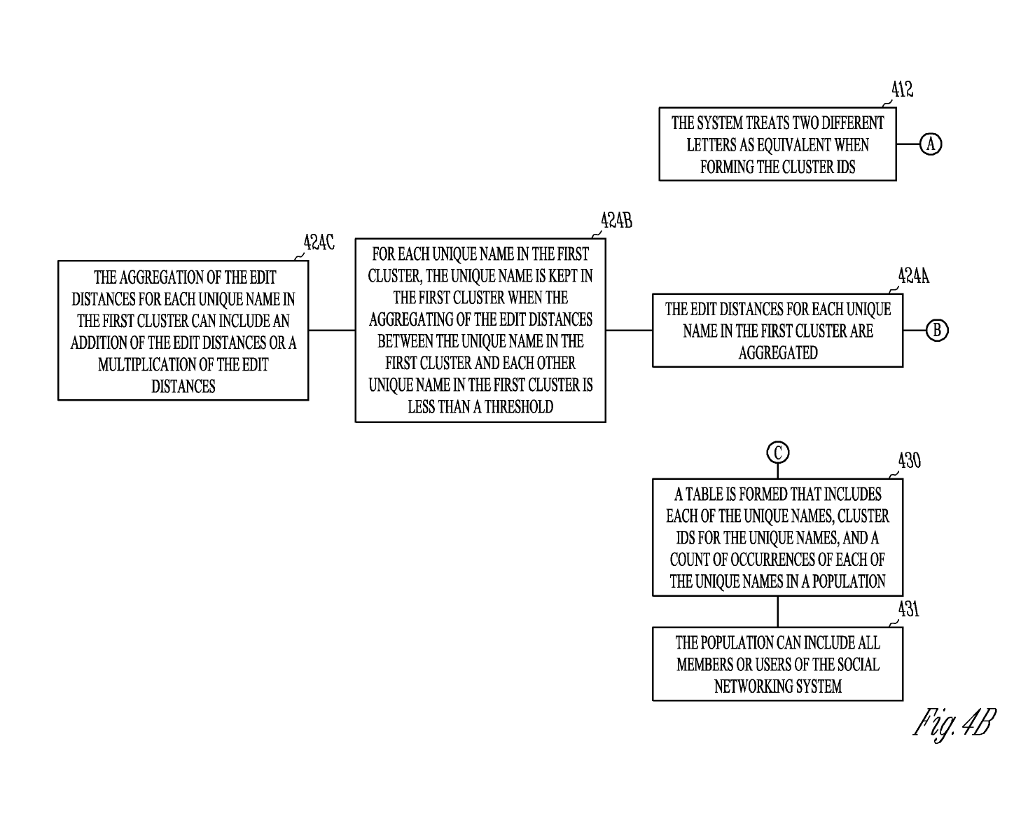

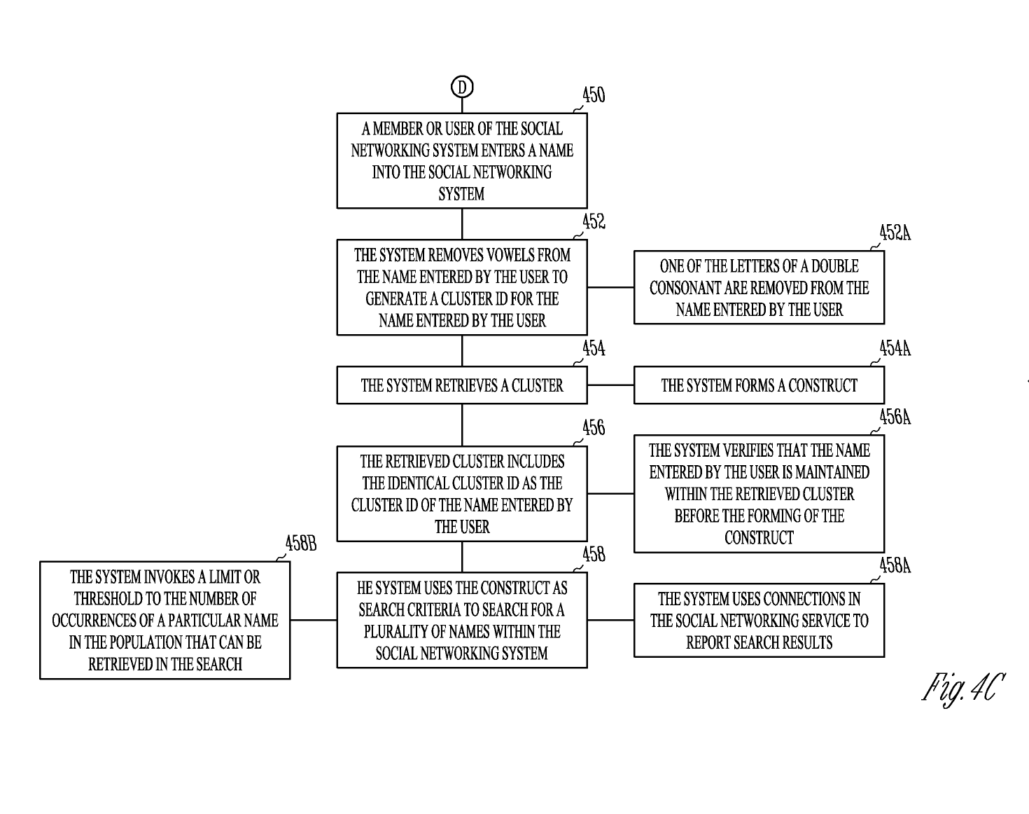

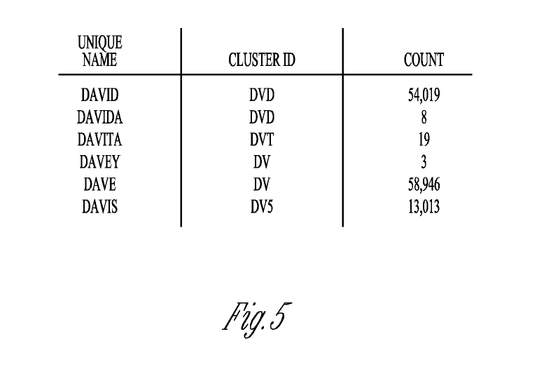

FIGS. 4A, 4B, and 4C are a block diagram illustrating operations and features of a process and system for a search engine using name clustering. FIGS. 4A, 4B, and 4C include a number of process blocks 405-458B. Though arranged substantially serially in the examples of FIGS. 4A, 4B, and 4C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 4A, 4B, and 4C, at 405, a plurality of names is received into a social and/or business networking system. This receiving of names can be in association with registering users or members of the social networking service. At 410, the social networking system removes one or more vowels from each of the plurality of names. This removal of vowels from the names generates what can be referred to as cluster ids. For example, the names David, Davida, Davita, Davey, Dave, and Davis generate the cluster ids dvd, dvd, dvt, dvy, dv, and dvs respectively. In an embodiment, as indicated at 411, double consonants are identified and one of the consonants is removed from the names before generating the plurality of cluster ids. For example, with the name “Matthew,” the cluster id of mthw would be formed (that is, removing one of the double “t's”).

At 412, the system treats two different letters as equivalent when forming the plurality of cluster ids. For example, the letters “c” and “k” may be treated as equivalent, so that the cluster ids for the names Cathy and Kathy, that is, cth and kth, are put into the same cluster. Then, as is explained below, a user searching for a Cathy in the social networking system will also automatically locate members with the name of Kathy.

At 415, a plurality of first clusters is formed by grouping together names having an equivalent cluster id. For example, the system may be configured such that it determines that dvd, dvy, and dv are equivalent cluster ids. In an embodiment, as indicated at 416, the system is configured to group together names that have an identical cluster id. Using the same example, an identical cluster id could be dvd, and all names that reduce to a cluster id of dvd would be placed into the same cluster (at least initially and prior to formation of a final cluster).

At 420, for each first cluster, an edit distance is determined. The edit distance measures a difference between each unique name in the first cluster and each other unique name in the first cluster. In a particular embodiment, as indicated at 421, the edit distance for each unique name in the first cluster is the number of operations that are needed to change the cluster id into the unique name. As indicated at 422, the operations include an addition of a letter to the cluster id, a change of a letter in the cluster id, and/or a substitution of a letter in the cluster id. For example, with a cluster id of dvd, it takes the additions of an “a”, an “i”, and another “a” to transform dvd into Davida. The edit distance in this instance would then be the value of 3. Additionally, the edit distance can include an aggregation of the number of operations to change each unique name in the cluster into each other unique name in the cluster. For example, if the cluster includes the names David, Davida, Davita, Davey, Dave, and Davis, the edit distance to transform David into each other unique name in the cluster is 8 (1+2+2+2+1) (1 to change David into Davida (add an “a”)), 2 to change David into Davita (change d to t and add an a), 2 to change David into Davey (change i to e and d to y), 2 to change David into Dave (change i to e and delete d), and 1 to change David into Davis (change d to s).

As just explained, and as noted at 424A, the edit distances for each unique name in the first cluster are aggregated, then at 424B, for each unique name in the first cluster, the unique name is kept in the first cluster when the aggregating of the edit distances between the unique name in the first cluster and each other unique name in the first cluster is less than a threshold. The remaining names are then kept in a cluster that can be referred to as a final cluster. At 424C, the aggregation of the edit distances for each unique name in the first cluster can include an addition of the edit distances or a multiplication of the edit distances.

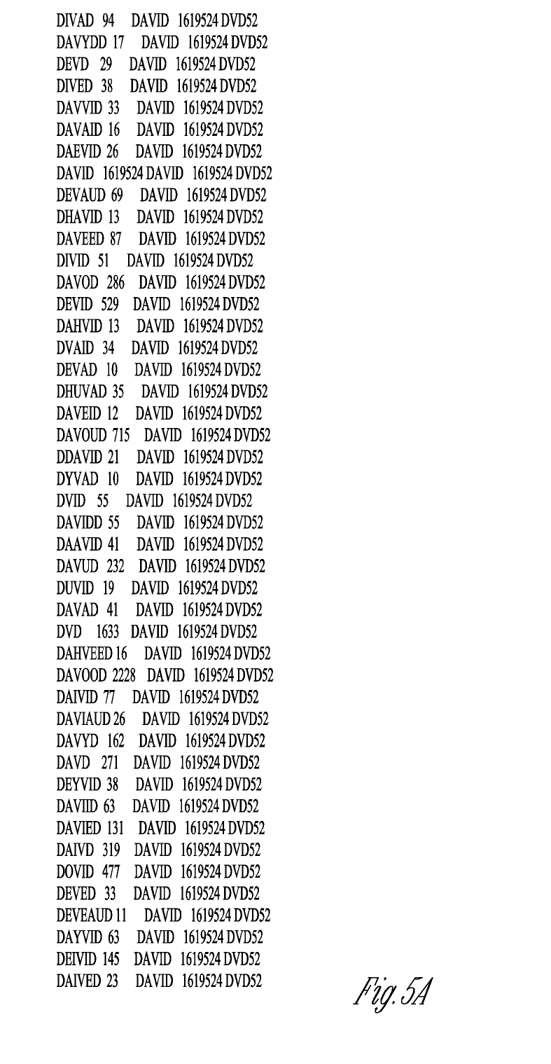

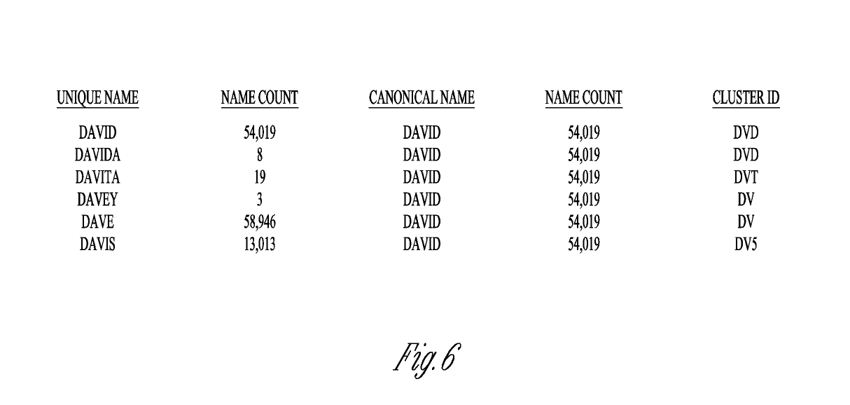

At 430, a table is formed that includes each of the unique names in a cluster, cluster ids for the unique names, and a count of occurrences of each of the unique names in the cluster or population. An example of such a table is illustrated in FIG. 5. As illustrated at 431, the population can include all members or users of the social networking system. At 435, a final cluster table is formed. The final cluster table can include each of the unique names, a number of occurrences of each of the unique names in the final cluster or population, an identification of a most commonly occurring name in the final cluster, a count of the most commonly occurring name in the final cluster, and the cluster id. The most commonly occurring name in the cluster can be referred to as the canonical name of the cluster. An example of a final cluster table is illustrated in FIG. 6.

It is noted that FIGS. 5 and 6 are relatively simple examples. FIG. 5A is a more realistic and complex example that illustrates many more names in a final cluster for the name David. As illustrated in FIG. 5A, the first column includes the many names or misspelling of names that map to a cluster of dvd. The second column includes the number of occurrences of that particular name in the population (such as a social or business network). The third column includes the canonical name for the cluster, and the fourth column includes the number of occurrences of the canonical name in the population. The last column is the cluster id identifier. In this example, it is referred to as dvd52 because there are other names that can reduce to a dvd cluster id (as is illustrated by the many unique names in this dvd52 cluster).

At 440, a name is removed from the final cluster when the number of times that the name occurs in the final cluster is less than a threshold. For example, the names David and Davida may be placed into the same cluster. However, the name David may occur thousands of times, but the name Davida may only occur eight times. In such an instance, if the threshold in a value of 10, then the name Davida would be removed from the dvd cluster. In another embodiment, this feature is used to ignore misspellings of names. For example, while the name David may occur in a cluster numerous times, the misspelling of David as Davit may only occur one or two times, and the “Davit” can be removed from the cluster since it will be less than the threshold.

The operations of 450-458B relate to the use of clusters in searching for members in the social network system 100. At 450, a member or user of the social networking system enters a name into the social networking system. At 452, the system removes vowels from the name entered by the user to generate a cluster id for the name entered by the user. At 452A, one of the letters of a double consonant are removed from the name entered by the user. At 454, the system retrieves a cluster. The retrieved cluster has an equivalent cluster id as the cluster id of the name entered by the user. At 456, the system forms a construct. The construct includes the name entered by the user and a plurality of unique names in the retrieved cluster. For example, if the user enters the name Dave, the construct will include the names Dave, David, and Davis.

At 454A, the retrieved cluster includes the identical cluster id as the cluster id of the name entered by the user. For example, if the user enters the name Dave, only the cluster with the cluster id of dv will be retrieved. In another embodiment, other similar clusters are retrieved such as the dvd cluster created from the name David.

At 456A, the system verifies that the name entered by the user is maintained within the retrieved cluster before the forming of the construct. For example, if the user enters the name “Davit”, the system checks the dvt cluster to verify that the name “Davit” is actually in the Dvt cluster. This feature relates to two issues. First, it avoids adding misspellings of names to a search construct (in the case wherein “Davit” is a misspelling of “David”). Second, it avoids adding a name to the search construct that is not in the social networking system or other population (in the case wherein “Davit” is not a misspelling, but it is not a name that is in the social networking system).

At 458, the system uses the construct as search criteria to search for a plurality of names within the social networking system or other population. For example, if the user enters the name David, the system will add to the search construct other unique names from the dvd construct - - - for example, Davida. At 458A, the system uses connections in the social networking service to report search results. With this feature, only the names of members with which the user has a connection are returned to the user.

At 458B, the system invokes a limit or threshold to the number of occurrences of a particular name in the population that can be retrieved in the search. For example, if the user enters the name of David, the system may limit the number of occurrences of “David” returned (which can be expected to be very high) in the search. This feature is helpful to a user who is interested in a particular name such as David, and such user does not want to be inundated with a more popular version of David such as Dave.

In an embodiment, cluster support is provided for prefixes of names by placing the prefixes of names into an appropriate cluster. Such name prefixes can be used in instant or type-ahead searches. For example, for the name “Agrawal”, the prefix “Agraw” can be placed into the same cluster as the names “Agrawal”, “Agarwal”, “Aggarwal”, etc. Cluster support for prefixes can be configured in a manner such that it is implemented only for prefixes that complete into a single cluster. For example, the prefix “Agra” may not be included in the current example because, without the “w”, it completes to other names that are not in the cluster. However, in another embodiment, cluster support for prefixes could be configured in such a manner that the system handles prefixes that complete to more than one cluster.

While the search engine using name clustering has been described above in relation to a particular embodiment that uses additions, deletions, and substitutions of letters in a name to generate cluster ids, and the calculation of an edit distance to determine the names within the final cluster, other means of generating clusters could be used. Specifically, such a general method could involve simply generating cluster ids based on the similarity of names (using some type of similarity evaluation), forming clusters by grouping names having an equivalent or similar cluster id, and maintaining or removing names from a cluster based on the how similar a particular name is to each other unique name in the cluster.

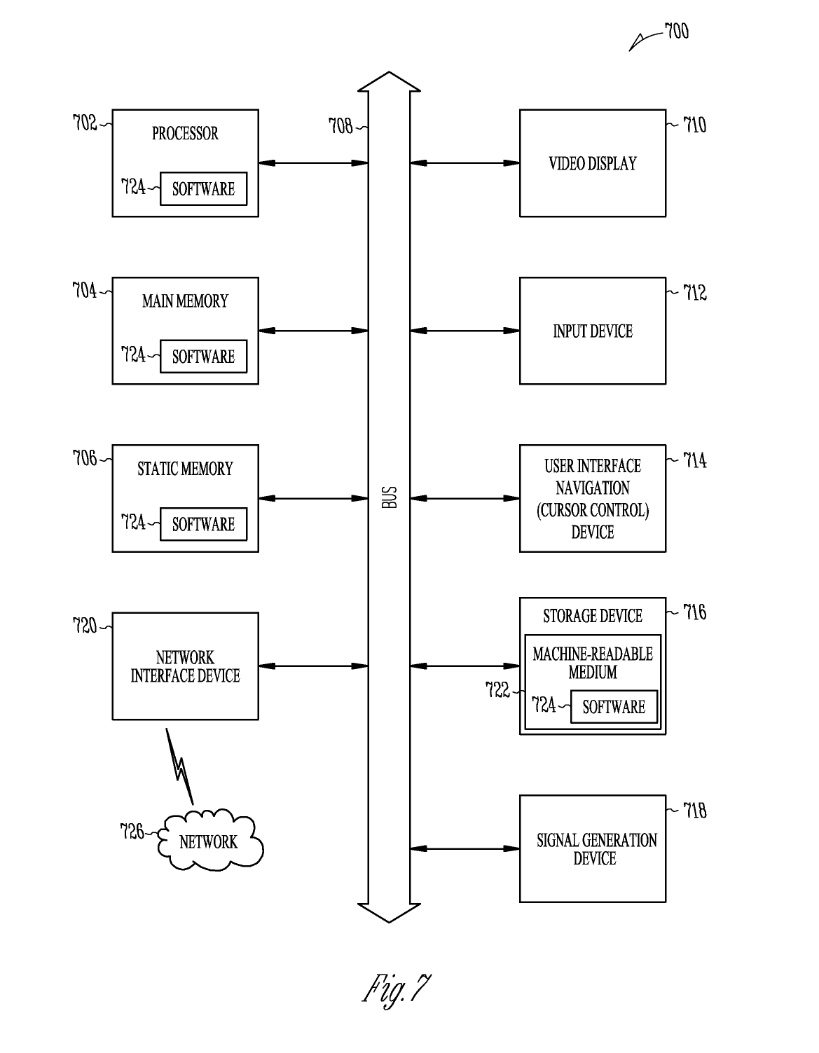

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software) for causing the machine 700 to perform any one or more of the methodologies discussed herein may be executed. In alternative examples, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 824 (e.g., software) embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A process comprising:
receiving into a computer processor a plurality of names;
removing one or more vowels from each of the plurality of names, thereby generating a plurality of cluster ids;
forming a plurality of first clusters by grouping names having an equivalent cluster id;
for each first cluster, determining an edit distance between each unique name in the first cluster and each other unique name in the first cluster;
aggregating the edit distances for each unique name in the first cluster; and
for each unique name in the first cluster, keeping the unique name in the first cluster when the aggregating of the edit distances between the unique name in the first cluster and each other unique name in the first cluster is less than a threshold, thereby generating a final cluster.

2. The process of claim 1, comprising identifying double consonants in the plurality of names, and for each name comprising one or more double consonants, removing one of the consonants of the double consonants before generating the plurality of cluster ids.

3. The process of claim 1, wherein the edit distance for each unique name in the first cluster comprises a number of operations that are needed to change the cluster id into the unique name.

4. The process of claim 3, wherein the operations comprise one or more of an addition of a letter to the cluster id, a change of a letter in the cluster id, and a substitution of a letter in the cluster id.

5. The process of claim 1, comprising forming a table comprising each of the unique names, cluster ids for the unique names, and a count of occurrences of each of the unique names in a population.

6. The process of claim 5, wherein the population comprises users or members of a social networking service.

7. The process of claim 1, comprising forming a final cluster table comprising each of the unique names, a number of occurrences of each of the unique names in a population, an identification of a most commonly occurring name in the final cluster, a count of the most commonly occurring name in the final cluster, and the cluster id.

8. The process of claim 1, comprising removing a name from the final cluster when the number of times that the name occurs in the final cluster is less than a threshold.

9. The process of claim 1, comprising:
receiving into the computer processor a name entered by a user;
removing vowels from the name entered by the user to generate a cluster id for the name entered by the user;
retrieving a second cluster having an equivalent cluster id as the cluster id of the name entered by the user; and
forming a construct comprising the name entered by the user and a plurality of unique names in the second cluster.

10. The process of claim 9, wherein the second cluster comprises an identical cluster id as the cluster id of the name entered by the user.

11. The process of claim 9, comprising verifying that the name entered by the user is maintained within the second cluster before the forming of the construct.

12. The process of claim 9, comprising removing double consonants from the name entered by the user before generating a cluster id for the name entered by the user.

13. The process of claim 9, comprising searching for a plurality of names within a population using the construct as search criteria.

14. The process of claim 13, comprising using connections in a social networking service to report search results such that only names of members with which the user has a connection are returned to the user.

15. The process of claim 13, comprising limiting to a threshold a retrieval of a particular name in the population during the searching.

16. The process of claim 15, comprising limiting a retrieval of a second plurality of names in the population to a threshold for each different name in the second plurality of names.

17. The process of claim 1, wherein two different letters are treated as equivalent when forming the plurality of cluster ids.

18. The process of claim 1, wherein the aggregation of the edit distances for each unique name in the first cluster comprises an addition of the edit distances or a multiplication of the edit distances.

19. The process of claim 1, wherein the first clusters are formed by grouping names having an identical cluster id.

20. The process of claim 1, comprising:
generating a prefix for a particular name; and
placing the prefix into the final cluster for the particular name.

21. A process comprising:
receiving into a computer processor a plurality of names;
generating a plurality of cluster ids based on the names;
forming a plurality of first clusters by grouping names having an equivalent cluster id; and
for each first cluster, and for each unique name in each first cluster, keeping the unique name in the first cluster when the unique name is similar to each other unique name in the first cluster, thereby generating a final cluster.

22. The process of claim 21, comprising:
receiving into the computer processor a name entered by a user;
generating a cluster id for the name entered by the user;
retrieving a second cluster having an equivalent cluster id as the cluster id of the name entered by the user; and
forming a construct comprising the name entered by the user and a plurality of unique names in the second cluster.

23. The process of claim 22, comprising searching for a plurality of names within a population using the construct as search criteria.
